(19) United States
(12) Patent Application Publication
(10) Pub. No.: US 2026/0362487 A1
(43) Pub. Date: Nov. 12, 2026

(54) NON-PRIMARY CHANNEL ACCESS (NPCA) SWITCHING BETWEEN THE BSS PRIMARY CHANNEL AND THE NPCA PRIMARY CHANNEL

(71) Applicants: SONY GROUP CORPORATION, Tokyo (JP); SONY CORPORATION OF AMERICA, New York, NY (US)

(72) Inventor: Qing Xia, San Jose, CA (US)

(73) Assignees: SONY GROUP CORPORATION, Tokyo (JP); SONY CORPORATION OF AMERICA, New York, NY (US)

(21) Appl. No.: 19/642,020

(22) Filed: Apr. 8, 2026

Related U.S. Application Data
(60) Provisional application No. 63/803,205, filed on May 9, 2025.

(51) Int. Cl. H04W 74/0816; H04W 56/00; H04W 84/12

(52) U.S. Cl. CPC H04W 74/0816; H04W 56/0015; H04W 84/12

(57) ABSTRACT

Non-primary channel access (NPCA) switching between the BSS primary channel and the NPCA primary channel is described. A wireless communication protocol which addresses medium synchronization recovery when NPCA STAs switch between the BSS primary channel and the NPCA primary channel (in both directions) is also described. Solutions include mechanisms for NPCA STA/AP to perform an early switch back when the OBSS TXOP is truncated on the BSS primary channel.

### CROSS-REFERENCE TO RELATED APPLICATIONS

This application claims priority to, and the benefit of, U.S. provisional patent application serial number 63/803,205 filed on May 9, 2025, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to wireless communications under IEEE 802.11, and more particularly to medium synchronization recovery for Non-Primary Channel Access (NPCA) STAs/APs switching between the BSS primary channel and the NPCA primary channel.

### 2. Background Discussion

Present NPCA wireless protocols do not address medium synchronization recovery when NPCA STA(s) switch between the primary channel and the NPCA primary channel, and address early switch backs when OBSS TXOP is truncated on the BSS primary channel.

Accordingly, a need exists for an improved NPCA protocol that addresses synchronization and switch backs. The present disclosure fulfills that need and provides additional benefits over existing systems.

### BRIEF SUMMARY

Apparatus and methods are described for medium synchronization recovery for NPCA STA/AP switching between the primary channel and the NPCA primary channel (in both directions). Diverse solutions are designed for the mechanism for NPCA STA/AP to perform an early switch back (e.g., earlier than at the end of the OBSS TXOP) when the OBSS TXOP is truncated on the BSS primary channel. Comprehensive conditions are proposed for NPCA STA/AP to perform this early switch back.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a chart of Clear Channel Assessment (CCA) Sensitivity threshold for the 20MHz bandwidth (BW) for current systems.

FIG. 2 is a block diagram of communication station hardware, according to at least one embodiment of the present disclosure.

FIG. 3 is a block diagram of Multi-Link Device (MLD) hardware according to at least one embodiment of the present disclosure.

FIG. 4 is an example topology utilized, according to at least one embodiment of the present disclosure.

FIG. 5 is a communications diagram showing medium access recovery for a STA (NPCA AP or NPCA STA), according to at least one embodiment of the present disclosure.

FIG. 6 is a communications diagram showing lost medium synchronization after it switches back from the NPCA primary channel to the BSS primary channel, according to at least one embodiment of the present disclosure.

FIG. 7 is a communications diagram of a STA that doesn’t experience a loss of medium synchronization after it switches back from the NPCA primary channel to the BSS primary channel, according to at least one embodiment of the present disclosure.

FIG. 8 is a communications diagram of early TXOP termination detection on the BSS primary channel, and continuing CS on the BSS primary channel, according to at least one embodiment of the present disclosure.

FIG. 9 is a communications diagram of early TXOP termination detection on a BSS primary channel with notification sent by a wideband non-NPCA STA, according to at least one embodiment of the present disclosure.

FIG. 10 is a communications diagram of early TXOP termination detection on the BSS primary channel with notifications sent by an OBSS NPCA STA/AP, according to at least one embodiment of the present disclosure.

### DETAILED DESCRIPTION

### 1. Introduction

Non-Primary Channel Access (NPCA) was developed during IEEE 802.11bn to improve low latency performance when the Basic Service Set (BSS) primary channel is interfered with by an Other Basic Service Set (OBSS) transmission. A Station (STA) that supports NPCA operation is called an NPCA station (NPCA STA); and an AP that supports NPCA operation is called an NPCA Access Point (NPCA AP). A station utilizing NPCA does not necessarily need to be a multiple-link device (MLD), yet is a station that has access to a secondary channel (secondary primary channel) if the main primary channel is busy or otherwise interfered with or unavailable.

An NPCA STA may switch from its BSS primary channel to the NPCA primary channel for NPCA operation if either condition (1) or (2) are met:
(1) The STA received an inter-BSS Physical layer Protocol Data Unit (PPDU) on the BSS primary channel and the duration of the PPDU or the duration of the PPDU plus the value of the Receiver Vector (RXVECTOR) parameter indicating duration of the Transmit Opportunity (TXOP) (as TXOP_DURATION) of the PPDU, exceeds the value indicated in the most recently received or transmitted NPCA Minimum Duration Threshold. In addition, the 20/40/80/160 MHz channel occupied by the PPDU is identified by the STA and the channel occupied by the PPDU does not overlap with the NPCA primary channel.
(2) The STA received an inter-BSS PPDU containing a Control frame and an inter-BSS PPDU containing an initial response frame of a Control frame exchange on the BSS primary channel and the TXOP duration as determined from the received PPDUs is greater than the latest value of NPCA Minimum Duration Threshold and the PPDU(s) bandwidth does not overlap with the NPCA primary channel.

The NPCA Access Point (AP) and NPCA STA shall indicate or announce its NPCA switch delay and NPCA switch back delay. An NPCA AP may disable untriggered Uplink (UL) transmissions on the NPCA primary channel by NPCA STAs. If the NPCA AP/STA switches from the BSS primary channel to the NPCA primary channel based on meeting condition (1) above, then the STA shall initiate the switch at the NPCA High Efficiency (HE) switch time and shall be ready to transmit and receive on the NPCA primary channel no later than the NPCA switching delay after the NPCA HE switch time.

If the STA switches from the BSS primary channel to the NPCA primary channel based on meeting condition (2) above, the STA shall initiate the switch at the NPCA Non-HT (NHT) switch time and shall be ready to transmit and receive frames on the NPCA primary channel no later than the NPCA switching delay after the NPCA NHT switch time. The STA should use the same Enhanced Distributed Channel Access (EDCA) parameter set, Multi-User (MU) EDCA parameter set, and Emergency Preparedness Communication Services (EPCS) EDCA parameter set values for operation on the NPCA primary channel as it uses on the BSS primary channel. Each time the STA switches to the NPCA primary channel, it shall initialize the parameter CW_NPCA [AC] and randomly choose a new initial value between 0 and CW-NPCA[AC] for the backoff counter (BO_NPCA[AC]). The parameter QSRC_NPCA[AC] shall be set to 0. However, if the STA is a non-AP STA and the associated AP has disabled the use of untriggered UpLink (UL) transmission on the NPCA primary channel for that STA, then the STA shall not initiate a Transmit Opportunity (TXOP) on the NPCA primary channel. Besides, The STA shall not initiate a transmission on the NPCA primary channel to another STA until that STA's NPCA switching delay time has elapsed since the NPCA HE switch time if switching due to condition (1) above, or NPCA NHT switch time if switching due to condition 2) above. The STA shall begin all frame exchanges on the NPCA primary channel with an NPCA Initial Control frame using non-HT PPDU or non-HT duplicate Physical Layer Protocol Data Unit (PPDU) format using a rate of 6 Mb/s, 12 Mb/s, or 24 Mb/s.

An NPCA AP that transmits a Trigger frame on the NPCA primary channel shall indicate Resource Unit (RU) index values that use the NPCA primary channel as the reference primary channel. The Trigger frame shall include an explicit indication that it is being transmitted on the NPCA primary channel. The 20 MHz channels occupied by PPDUs transmitted by the STA shall meet the conditions of including, at least, the NPCA primary channel, and all be within the BSS bandwidth, and not including any of the channels occupied by the inter-BSS traffic that caused the STA to switch from the BSS primary channel to the NPCA primary channel, and not including channels that are indicated as punctured in the Disabled Subchannel Bitmap field in the Extra-High Throughput (EHT) Operation element.

### 2. Current State of the Art

### 2.1. CCA Sensitivity for the Primary 20 MHz Bandwidth

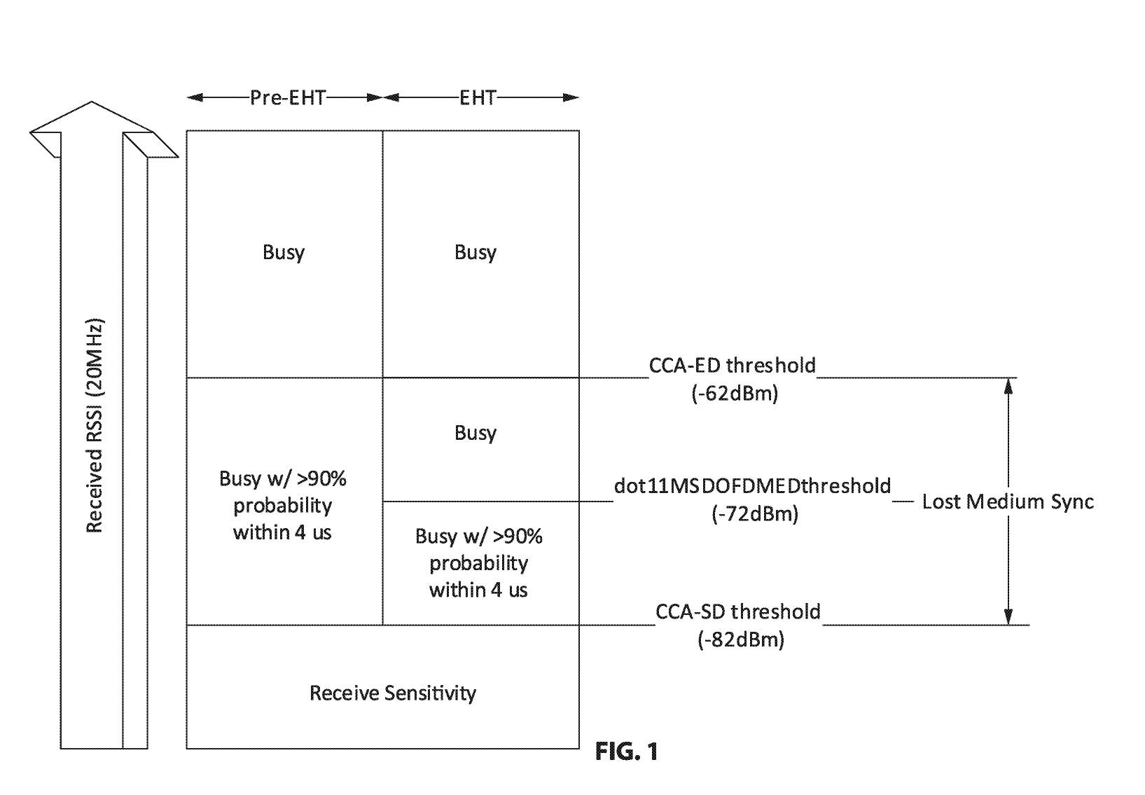

FIG. 1 depicts the Clear Channel Assessment (CCA) Sensitivity threshold for the 20MHz bandwidth (BW). In the left of the figure is a vertical arrow indicating Received Signal Strength Indicator (RSSI) received for the 20 MHz channel. There are columns for Pre-HT and EHT; which indicate their busy status, with threshold levels CCA-ED (-62 dBm), dot11MSDOFDMED (-72DBm), and CCA-SD (-82 dBm), and an area of Lost medium synchronization.

For pre-Extra High Throughput (EHT) STA with the operating channel width equal to 20 MHz, the start of a 20 MHz signal at a receive level greater than or equal to the minimum modulation and coding rate sensitivity of –82 dBm shall cause the PHY to set parameter PHY-CCA.indication(BUSY) with a probability of greater than 90% within 4 microseconds (us). The receiver shall indicate a channel busy condition for any signal 20 dB, or more, above the minimum modulation and coding rate sensitivity (–82 + 20 = –62 dBm) in the 20 MHz channel. For an EHT STA, the receiver shall issue a PHY-CCA.indication primitive with the STATUS parameter set to BUSY for any signal that exceeds the threshold below in the primary 20 MHz channel within a period of a CCATime after the signal arrives at the receiver’s antenna(s): (a) a value specified by dot11MSDOFDMEDthreshold if any MediumSyncDelay timer at that STA has not expired. (b) A value of -62 dBm otherwise, where –62 dBm is 20 dB above the minimum modulation and coding rate sensitivity (–82 + 20 = –62 dBm).

### 3. Problem Statement

The current protocols are not configured to address medium synchronization recovery when NPCA STA(s) switch between the primary channel and the NPCA primary channel. Specifically, there is a lack of mechanisms for NPCA STA/AP to perform an early switch back when OBSS TXOP is truncated on the BSS primary channel. There is also a lack of specified conditions for NPCA STA/AP to perform an early switch back.

### 4. Approach To Addressing the Problem

Medium synchronization recovery mechanisms are described herein for NPCA STA/AP switching between the primary channel and the NPCA primary channel (in both directions). Diverse solutions are designed for the mechanism for NPCA STA/AP to perform an early switch back (e.g., earlier than at the end of the OBSS TXOP) when the OBSS TXOP is truncated on the BSS primary channel. Comprehensive conditions are proposed for NPCA STA/AP to perform this early switch back.

### 5. Embodiments of the Present Disclosure

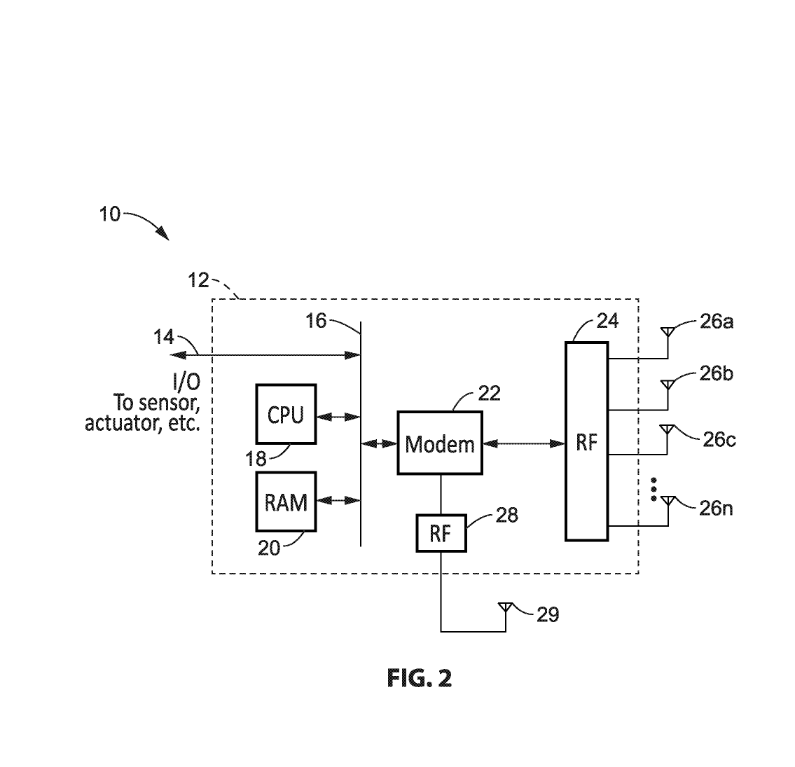

FIG. 2 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., Random Access Memory (RAM)) 20 for executing a program(s) which implements the described communication protocol. The host machine accommodates at least one modem 22 to support communications coupled to at least one Radio Frequency (RF) module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the Central Processing Unit (CPU), such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA Hardware (HW) is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a Multi-Link Device (MLD), which typically will have a processor and memory for coordinating activity, although it should be appreciated that these resources may be shared as there is not always a need for a separate CPU and memory for each STA within the MLD.

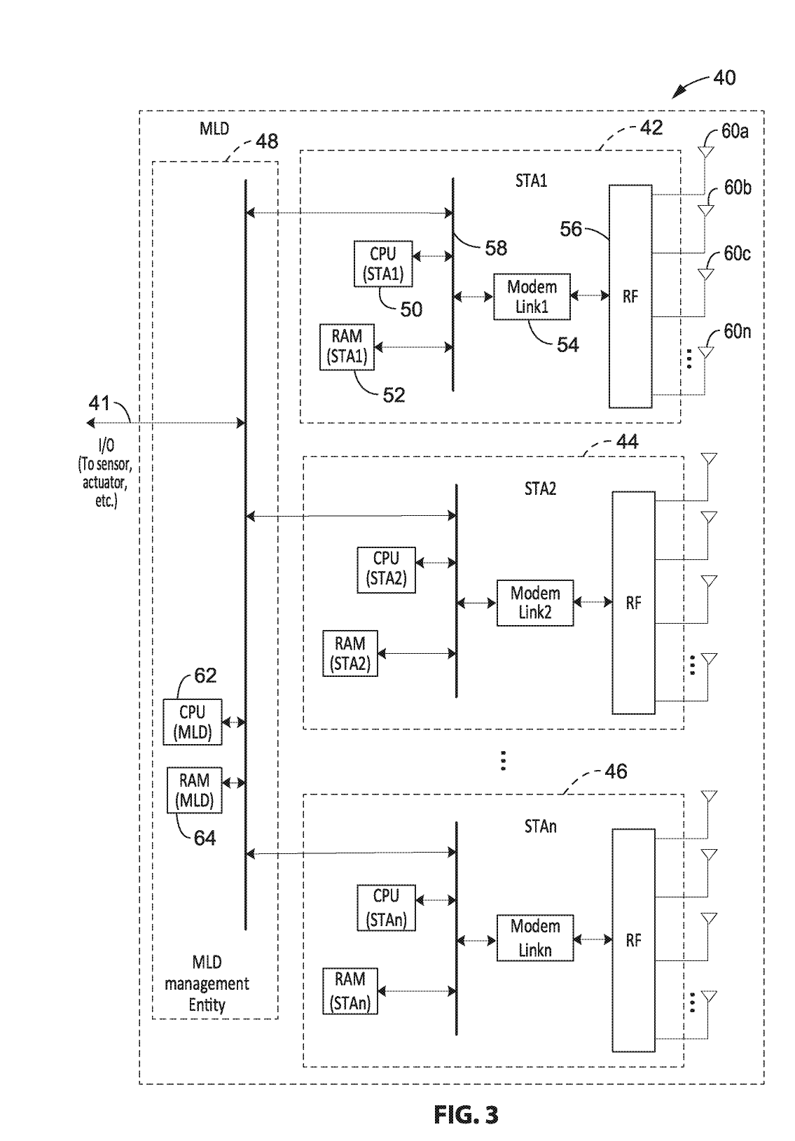

FIG. 3 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4GHz, 5GHz and 6GHz. Among multiple radios, basic link sets are the link pairs that satisfy simultaneous transmission and reception (STR) mode, e.g., basic link set (2.4 GHz and 5 GHz), basic link set (2.4 GHz and 6GHz).

The conditional link is a link that forms a Non-Simultaneous Transmission and Reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external Input/Output (I/O) access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs. In at least one embodiment the MLD has an I/O channel 41 such as to/from sensors, actuators, and other wired units, or connecting to a controller for other forms or wired/wireless I/O communication.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 6. Topology

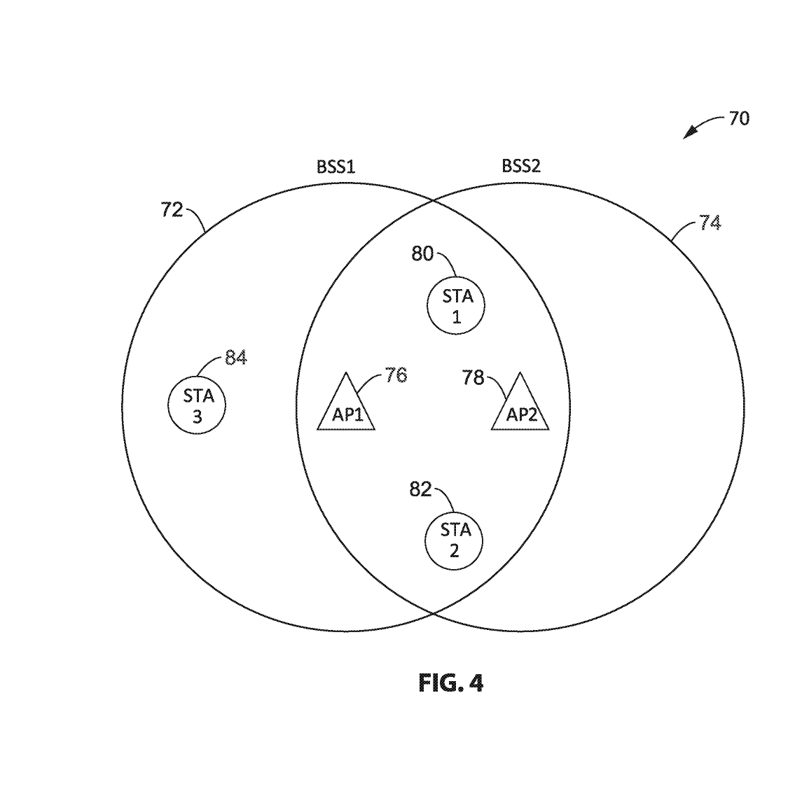

FIG. 4 illustrates an example network topology 70, provided for the sake of illustration and not limitation, consisting of two BSSs, which are denoted as BSS1 72 and BSS2 74. BSS1 is the BSS under study where AP1 is allocated in the center of BSS1. STA1 80, STA2 82 and STA3 84 are all associated with AP1 76 and randomly distributed in BSS1. AP1, STA1 and STA3 are 11bn Ultra-High Reliability (UHR) devices which are capable of supporting 11bn features, such as NPCA. STAb2 is a non-UHR device that doesn’t support NPCA.

BSS2 74 has an AP2 78 allocated in the center, the associated STAs of AP2 are not shown in this figure for the sake of simplicity of illustration. However in reality, there are STAs affiliated with AP2 and distributed within BSS2.

### 7. Protocol Design

### 7.1. Medium Access Recovery Procedure for NPCA STAs

7.1.1. Medium Access Recovery after Switching to NPCA Primary Channel

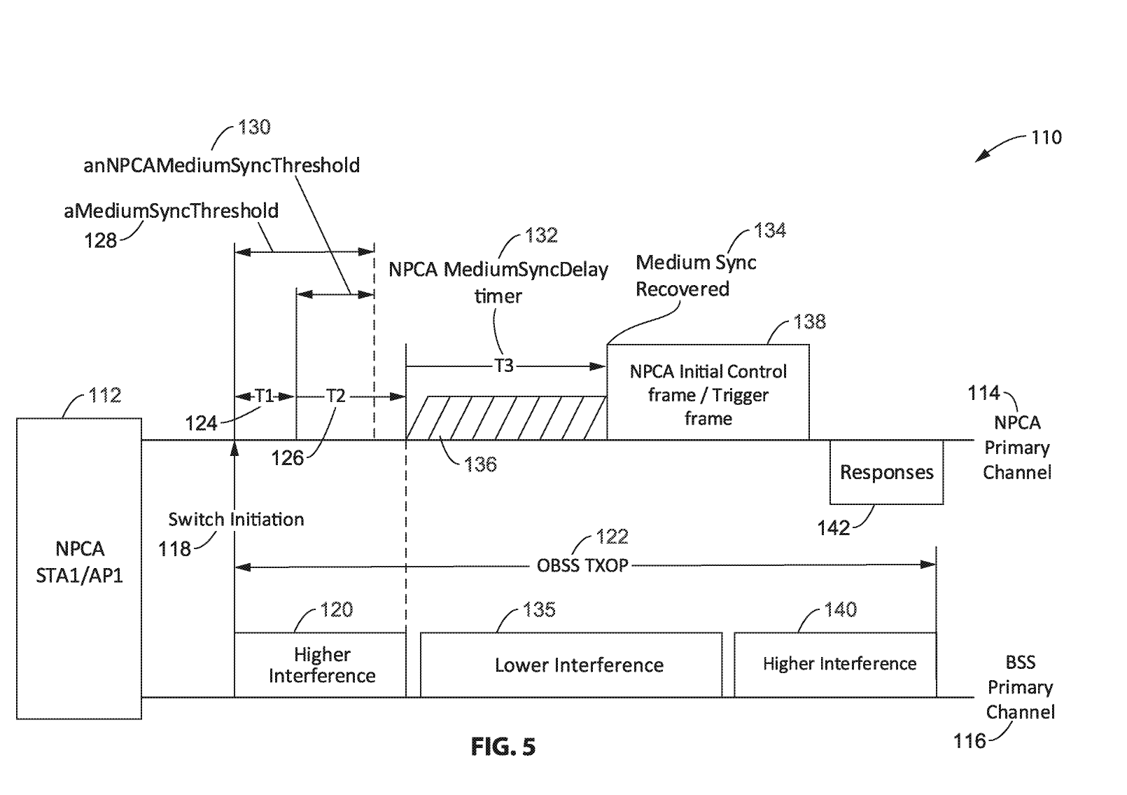

FIG. 5 illustrates communication medium access recovery 110 for a STA 112 that could be either an NPCA AP or an NPCA STA. The NPCA rules as introduced in Section 1 shall be applied to the STA.

It will be noted that to perform communication medium access recovery, a STA must be able to maintain an accurate, up-to-date view of its state (e.g., idle/busy), as well as contention window, ongoing traffic, toward preventing collisions and ensuring a proper recovery process. Loss of synchronization can arise due to simultaneous, unaligned traffic on the main and non-primary channels, or simply by not sufficiently monitoring the non-primary channel.

The STA detects an interfering OBSS transmission on the BSS primary channel 116 and switches to the NPCA primary channel 114. On the BSS Primary channel 116 during the OBSS TXOP 122 there is shown a period of higher interference 120, followed by lower interference 135, and then higher interference 140. The value T1 124, within which it is determined that a switch is to be made, is the time value including the NPCA HE/NHT switch time and the actual NPCA switching delay.

The figure depicts switch initiation 118 between the BSS primary channel 116 to the NPCA Primary channel 114, and an OBSS TXOP 122. In at least one embodiment, after T1, the STA operating on the NPCA primary channel may be considered to have lost medium synchronization when the OBSS transmissions on the BSS primary channel 116 has caused a certain level of interference 120 on the NPCA primary channel 114, and the STA doesn’t have any valid previous virtual/physical Carrier Sense (CS) information on the NPCA primary channel, and the duration of the OBSS transmission on the primary channel that causes the STA lost medium synchronization on the NPCA primary channel is greater than aMediumSyncThreshold 128, where the value of aMediumSyncThreshold time 128 shall be chosen to cover at least the PPDU length of Ready-to-Send (RTS), Clear-to-Send (CTS), Acknowledgement (Ack) frames using non-High Throughput (HT) or non-HT duplicate PPDU format at a given data rate (e.g., 6 Mb/s data rate), as well as the PPDU length of a typical (e.g., most typical) BlockAck (BA) frame. Since the anNPCAMediumSyncThreshold 130 starts after T1, thus the value of anNPCAMediumSyncThreshold is calculated as aMediumSyncThreshold, T1 124.

In at least one embodiment, a STA that has lost medium synchronization on the NPCA primary channel shall start an NPCA MediumSyncDelay timer 132 and begin counting down 136 from the end of that OBSS transmission on the BSS primary channel that causes the STA lost medium synchronization on the NPCA primary channel if the OBSS transmission duration (shown as T1 extending through T2) is greater than aMediumSyncThreshold 128, or if the OBSS transmission duration after T1 is greater than anNPCAMediumSyncThreshold 130.

In at least one embodiment, the NPCA MediumSyncDelay timer (shown as T3 132) is a single timer, shared by all Enhanced Distributed Channel Access Functions (EDCAFs) within a STA, whose value is set to, In at least one embodiment, aPPDUMaxTime, which is based on Ultra-High Reliability (UHR) Physical (PHY) layer characteristics, such Modulation and Coding Scheme (MCS), operation bandwidth, number of spatial streams, Guard Interval (GI) duration, preamble fields, padding and Data field Orthogonal Frequency Division Multiplexing (OFDM) symbols, and so forth. In another embodiment, the NPCA MediumSyncDelay timer 132 duration is set to aPPDUMaxTime plus aSIFSTime plus the response time of the previous PPDU.

In at least one embodiment, the NPCA MediumSyncDelay timer resets to zero when the STA receives an MAC Protocol Data Unit (MPDU) on the NPCA primary channel or when the STA receives a PPDU on the NPCA primary channel for which the RXVECTOR parameter TXOP_DURATION is UNSPECIFIED.

In at least one embodiment, if a STA that operates on an NPCA primary channel has lost medium synchronization due to the OBSS transmission interference on the BSS primary channel, and its previous NPCA MediumSyncDelay timer has not expired, or been reset, or initialized, then at the end of the OBSS transmission, the STA shall continue the previous NPCA MediumSyncDelay timer except that the STA may initialize the NPCA MediumSyncDelay timer when the duration of OBSS transmission duration is greater than aMediumSyncThreshold.

In at least one embodiment, a STA that is capable of obtaining a TXOP while the NPCA MediumSyncDelay timer has a nonzero value shall use dot11NPCAMSDOFDMEDthreshold instead of dot11OFDMEDThreshold in order to detect a channel busy condition in the NPCA primary 20 MHz channel if the NPCA MediumSyncDelay timer has a nonzero value.

In at least one embodiment, the dot11NPCAMSDOFDMEDthreshold may or may not set to a value equals the dot11MSDOFDMEDthreshold. The dot11NPCAMSDOFDMEDthreshold shall be set to a value between -82dBm to -62dBm.

In at least one embodiment, if a STA is capable of obtaining a TXOP while the NPCA MediumSyncDelay timer has a nonzero value, it shall perform the transmission rules as introduced in Section 1 to transmit 138 an NPCA Initial control frame or NPCA trigger frame, and receive responses 140.

In at least one embodiment, the STA shall perform CCA with dot11OFDMED threshold for the primary 20 MHz channel of the NPCA primary channel when the NPCA MediumSyncDelay timer has expired before it initiates a transmission.

7.1.2. Medium Access Recovery after Switching Back to BSS Primary Channel

In at least one embodiment, the STA should be capable of obtaining and understanding the location of its OBSSs’ NPCA primary channel information e.g., channel index from the associated AP, which indicates that multiple neighboring APs should be able to exchange the information of its BSS primary channel with other APs as well as announce information to the associated STAs.

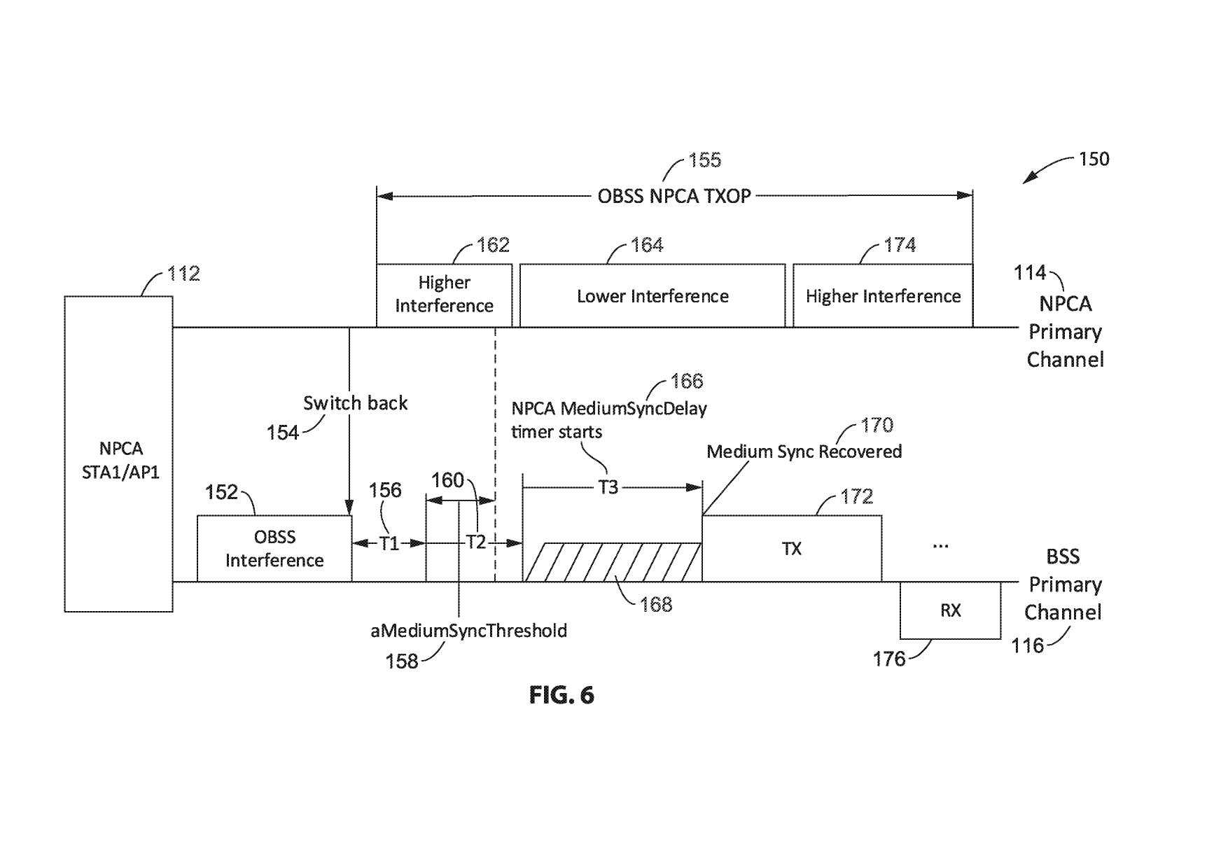

FIG. 6 illustrates an example scenario 150 of STA 112 lost medium synchronization after it switches back from the NPCA primary channel 114 to BSS primary channel 116. In the BSS Primary Channel 116 there is seen OBSS interference 152, and a switch back 154 is performed.

The NPCA primary channel is used by the OBSS NPCA transmission when the OBSS primary channel is occupied by, for example another BSS and the OBSS has the same NPCA primary channel as the STA or the OBSS has its NPCA primary channel located very close to the BSS primary channel of the STA. The OBSS NPCA transmission, which is on or close to the NPCA primary channel of the STA, interferes with the STA on the BSS primary channel and could cause a loss of medium synchronization on the STA on the primary channel. After the OBSS TXOP is finished on the BSS primary channel, the STA switches back 154 to the BSS primary channel. T1 156 is the time value including the NPCA HE or non-HE (NHT) switch time and the actual NPCA switching back delay.

In at least one embodiment, since the starting point of the higher interference transmission 162 from OBSS NPCA TXOP 155 on the NPCA primary channel may not align with the starting point of T1, only aMediumSyncThreshold 158 will be used to identify if the STA has lost medium synchronization on the BSS primary channel right after the OBSS NPCA transmission finished on the NPCA primary channel at the end of T2 160, aMediumSyncThreshold delay has been reached – whereafter, after interval T2 completes then the NPCA MediumSyncDelay timer starts.

In at least one embodiment, a STA that has lost medium synchronization on the BSS primary channel shall start an NPCA MediumSyncDelay timer T3 166 and begin counting 168 down from the end of that OBSS transmission on the NPCA primary channel that causes the STA lost medium synchronization on the BSS primary channel. The NPCA primary channel is shown during OBSS NPCA TXOP as having periods of both higher interference 162, 174, and lower interference 164. At the end of NPCA MediumSyncDelay timer T3 166, then medium synchronization is recovered 170 and a transmission 172 performed, a response to which is shown 176.

In at least one embodiment, if a STA that operates on an BSS primary channel has lost medium synchronization due to the OBSS transmission interference on the NPCA primary channel, and its previous NPCA MediumSyncDelay timer has not expired, or been reset or initialized, then at the end of the OBSS transmission 155, the STA shall continue the previous NPCA MediumSyncDelay timer except that the STA may initialize the NPCA MediumSyncDelay timer when the end of OBSS transmission is greater than aMediumSyncThreshold end point.

In at least one embodiment, a STA that is capable of obtaining a TXOP while the NPCA MediumSyncDelay timer has a nonzero value shall use dot11NPCAMSDOFDMEDthreshold instead of dot11OFDMEDThreshold in order to detect a channel busy condition in the BSS primary 20 MHz channel if the NPCA MediumSyncDelay timer has a nonzero value.

In at least one embodiment, the STA shall perform CCA with dot11OFDMED threshold for the primary 20 MHz channel of the BSS primary channel when the NPCA MediumSyncDelay timer has expired before it initiates a transmission.

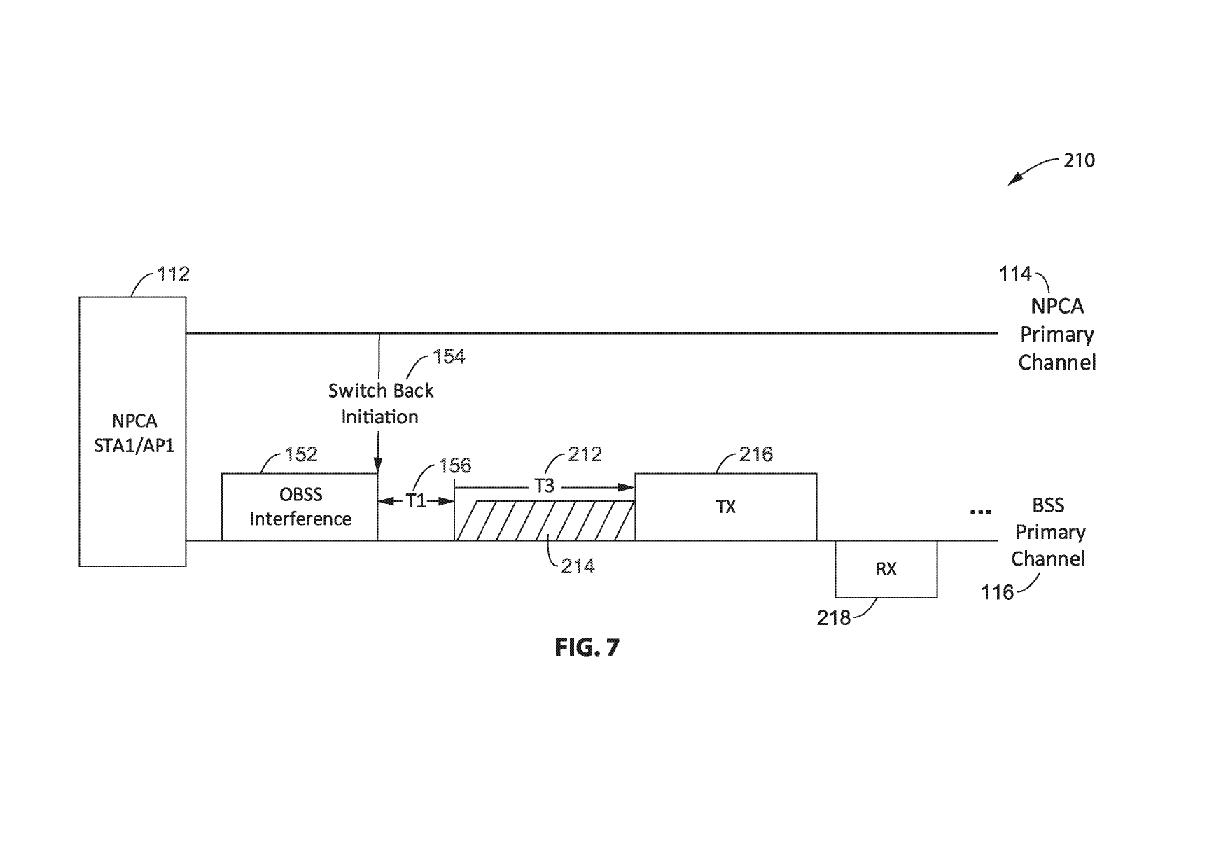

FIG. 7 illustrates a communications scenario 210 of a STA that doesn’t experience a loss of medium synchronization after it switches back from the NPCA primary channel 114 to the BSS primary channel 116, and NPCA primary channel is clear or idle. OBSS interference 152 arises on the BSS Primary Channel 116. After interference abates, such as when the OBSS TXOP has finished transmitting on the BSS primary channel, then the NPCA STA1/AP 112 switches back 154 to the BSS primary channel 116. T1 156 is the time value including the NPCA HE or NHT, switch time, and the actual NPCA switching back delay.

In at least one embodiment, after T1, the STA uses dot11OFDMEDThreshold T3 212, and starts counting down 214, in order to detect a channel busy condition in the BSS primary 20 MHz channel, after which it is seen transmitting 216, in response to which it receives a response 218.

7.2. Determine Early Termination of OBSS TXOP on the BSS Primary Channel

### 7.2.1. Keep CS on the BSS Primary Channel

In at least one embodiment, the STA supporting NPCA shall maintain at least one RF link just for use in Carrier Sensing (CS) on the BSS primary channel when the STA switches to the NPCA primary channel. The antenna(s) used for maintaining the RF link on the BSS primary channel shall keep processing CCA on the BSS primary channel. The antenna(s) used for maintaining the RF link on the BSS primary channel may not serve for transmission and may have limited capability for reception.

In at least one embodiment, the STA that maintains at least one RF link to process CCA on the BSS primary channel shall switch back from the NPCA primary channel to the BSS primary channel when it has identified that the OBSS TXOP has been terminated earlier than the pre-obtained TXOP duration on the BSS primary channel.

In at least one embodiment, the STA shall not initiate switching back if it is transmitting or receiving PPDU(s) on the NPCA primary channel. The STA should only initiate the switching back from NPCA primary channel to the BSS primary channel after it has completed its current transmission or reception.

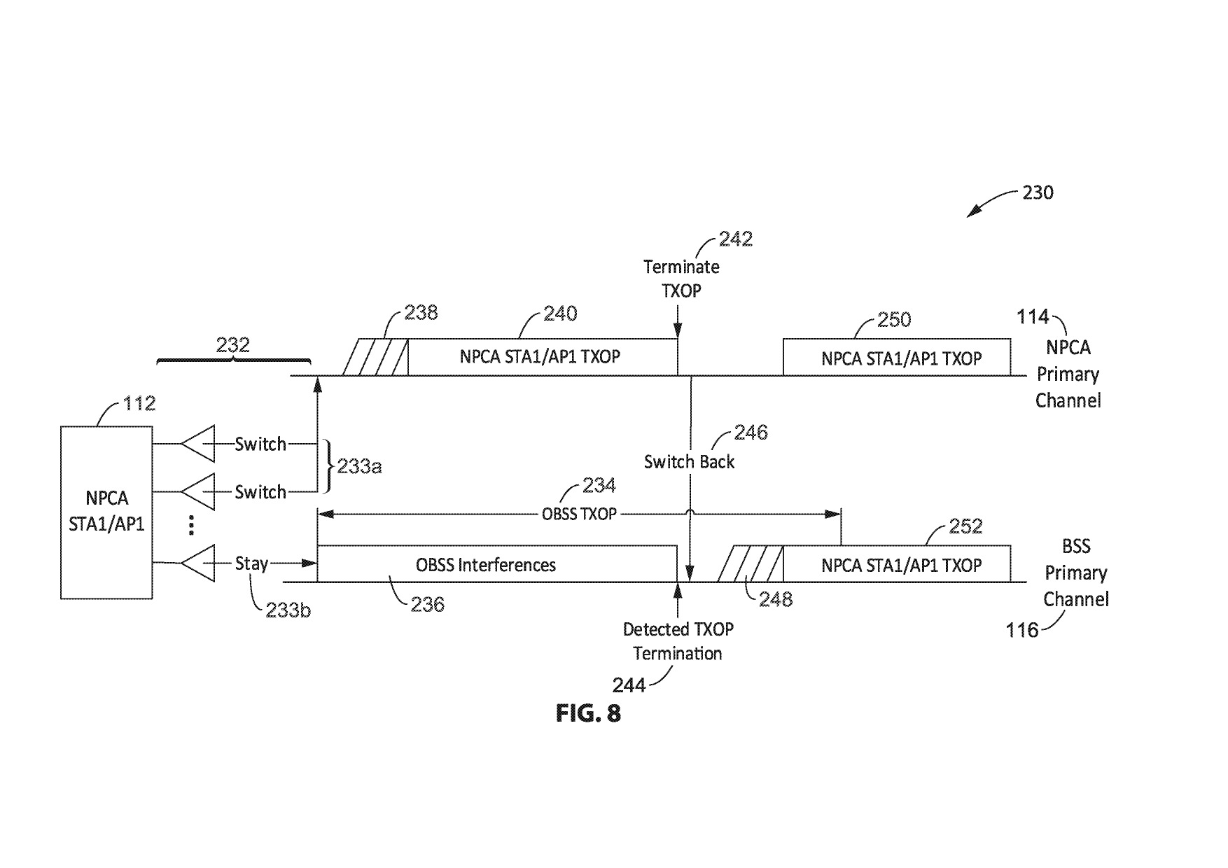

FIG. 8 illustrates an example 230 of early TXOP termination detection on BSS primary channel, and continuing CS on the BSS primary channel. The NPCA STA1/AP1 112 has multiple antennas 232 that originally enabled RF capability on the wideband channel that covers both the BSS primary channel 116 and the NPCA primary channel 114. An OBSS TXOP 234 is seen occupying the BSS primary channel, and there is OBSS interferences 236, wherein the NPCA STA1/AP1 shifts (switches) 233a a portion of its antenna capabilities to the NPCA primary channel and retains 233b at least one antenna to perform at least CCA on the BSS primary channel.

The NPCA STA1/AP1 is switched to the NPCA primary channel and contends 238 and obtains channel access for NPCA STA1/AP1 TXOP 240. Then the remaining antenna 233b of the NPCA STA1/AP1 on the BSS primary channel detects the termination of OBSS TXOP 244 and triggers the NPCA STA1/AP1 on the NPCA primary channel to terminate 242 the NPCA STA1/AP1 TXOP and initiate switch back 246. After that, the NPCA STA1/AP1 again enables full RF capability with all antennas on the wideband channel that covers both the BSS primary channel and the NPCA primary channel. The NPCA STA1/AP1 then contends 248 and obtains 252 access for the BSS Primary Channel in an NPCA STA1/AP1 TXOP 252 on the wideband channel, and an NPCA STA1/AP1 TXOP 250 performed on the NPCA primary channel.

### 7.2.2. Report from Wideband non-UHR STAs

In at least one embodiment, the legacy STA that does not support NPCA shall keep performing CCA when the OBSS TXOP is occupying the BSS primary channel. The operating band of the wideband non-UHR STA shall overlap with the NPCA primary channel of the NPCA STA(s) in the same BSS.

In at least one embodiment, the legacy STA can send a wide band signal through, such as in a non-HT duplicated PPDU format, when it has identified that the early OBSS TXOP termination occurs on the BSS primary channel and both the BSS primary channel and the NPCA primary channel are determined to not be CCA busy. Other channels could be punctured.

In at least one embodiment, the wide band signal should be broadcast. In this case, the NPCA STA and/or NPCA AP which received this signal shall be aware of the early OBSS TXOP termination on the BSS primary channel and shall initiate a process of switching back from the NPCA primary channel to the BSS primary channel.

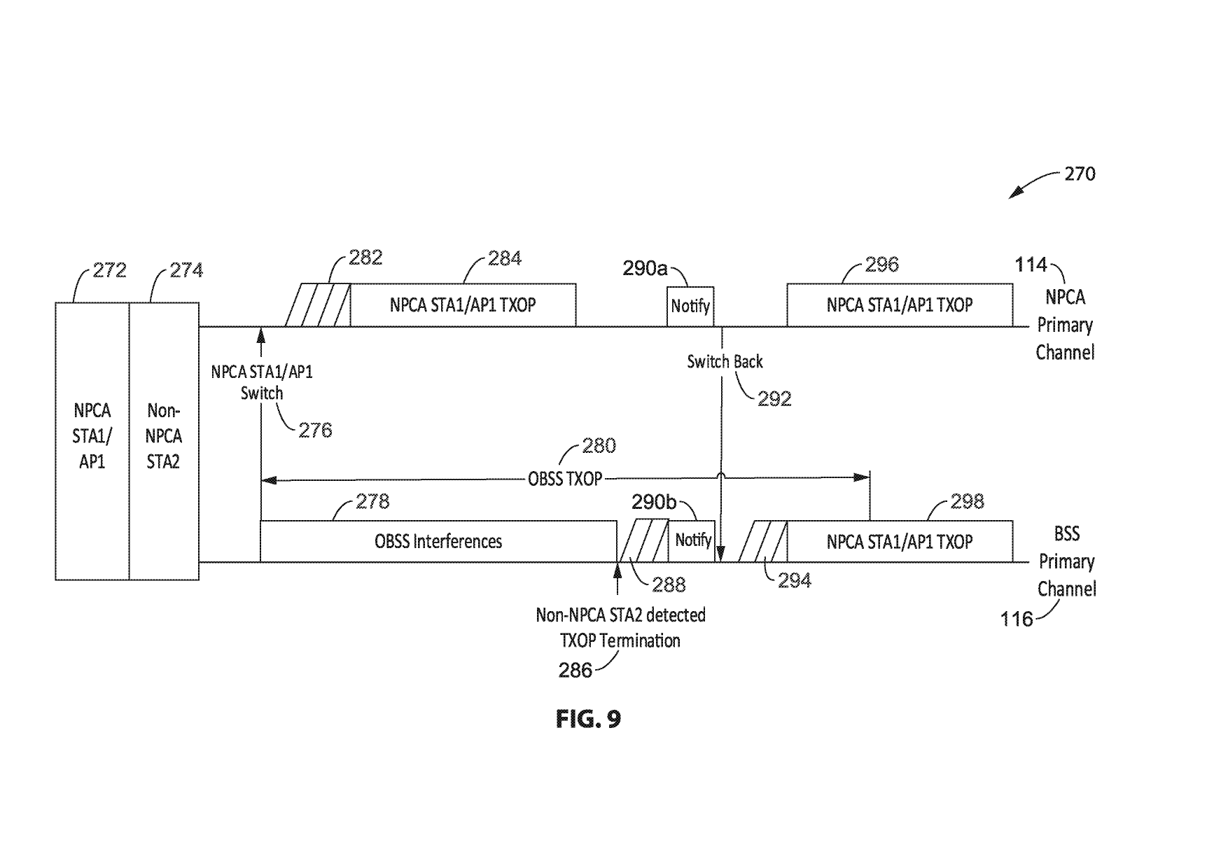

FIG. 9 illustrates an example 270 of early TXOP termination detection on a BSS primary channel 116 with notification sent by a wideband non-NPCA STA2 274. Both NPCA STA1/AP1 272 and non-NPCA STA2 274 are wideband devices whose operating band covers both the BSS primary channel 116 and the NPCA primary channel 114. When there is an OBSS TXOP 280, shown here with OBSS interference 278, occupying the BSS primary channel, in response to which the NPCA STA1/AP1 272 switches 276 to the NPCA primary channel 114.

The NPCA STA1/AP1 on the NPCA primary channel processes channel access, contends 282 for channel access and obtains channel access and performs transmission within an NPCA STA1/AP1 TXOP 284. Then the non-NPCA STA2 274 on the BSS primary channel detects the termination 286 of OBSS TXOP and processes CCA on both the BSS primary channel and the NPCA primary channel. After identifying that both channels are idle, the non-NPCA STA2 processes wideband channel access after random backoff 288 on the BSS primary channel. The non-NPCA STA2 broadcasts a Notify signal 290a after obtaining the TXOP on the wideband to announce the early termination of OBSS TXOP in the BSS primary channel. NPCA STA1/AP1 on the NPCA primary channel receives 290a the broadcasted Notification signal and initiates switch back, and switches back 292 to operate on the wideband channel that covers both the BSS primary channel and the NPCA primary channel. The NPCA STA1/AP1 process channel access on the wideband contends 292 for and obtains channel access and performs an NPCA STA1/AP1 TXOP 298 on the wideband channel, which is also received 296 on the NPCA primary channel.

### 7.2.3. Report from OBSS STAs

In at least one embodiment, an OBSS STA/AP that supports NPCA and whose operating band overlaps with both the BSS primary channel and the NPCA primary channel of the BSS shall announce the early OBSS TXOP termination on the NPCA primary channel of the BSS when the OBSS TXOP gets terminated on the BSS primary channel.

In at least one embodiment, the OBSS STA/AP shall only process the channel switch for the announcement when the OBSS STA/AP switching delay and the time of the announcement is less than the remaining duration between the early OBSS TXOP termination time and the pre-obtained TXOP limitation.

In another embodiment, the OBSS STA/AP shall only process the channel switch for the announcement when the OBSS STA/AP switching delay plus the OBSS STA/AP switching back delay plus the time of the announcement is less than the remaining duration between the early OBSS TXOP termination time and the pre-obtained TXOP limitation.

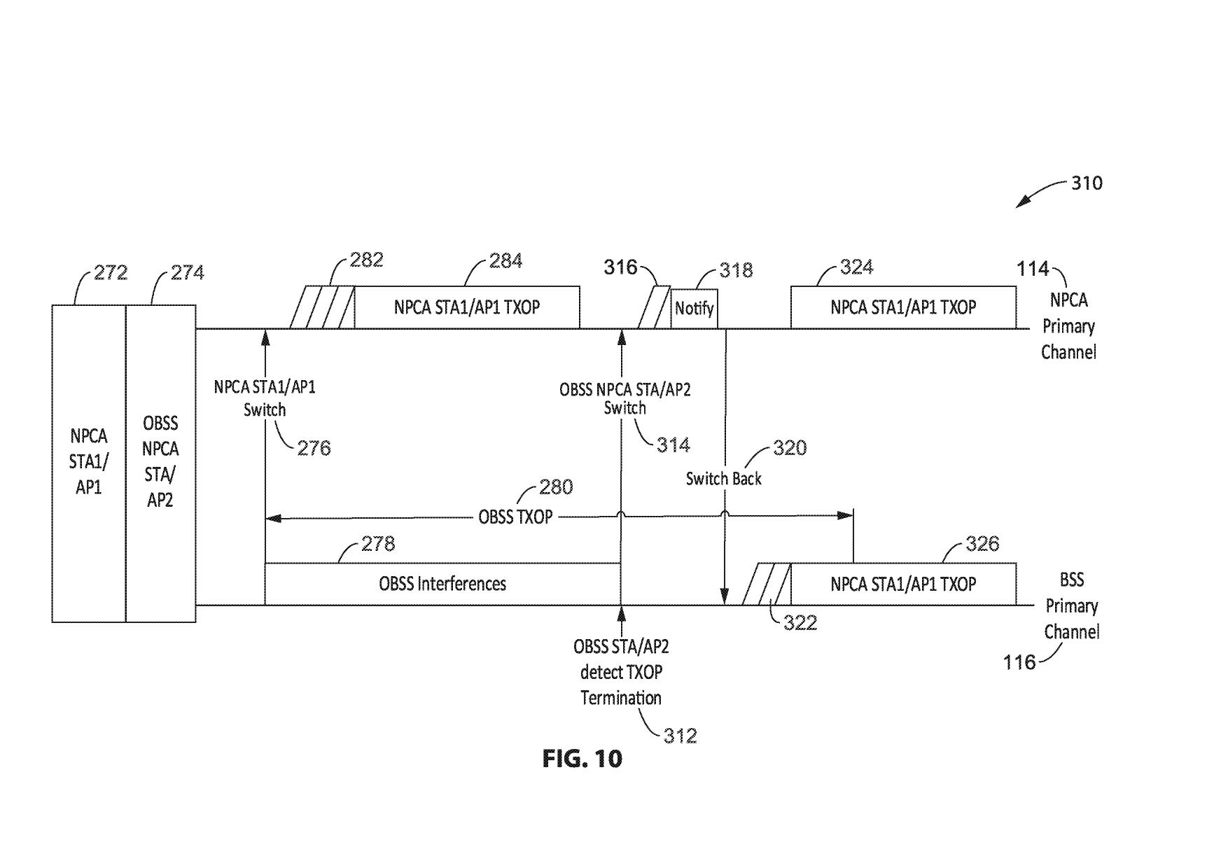

FIG. 10 illustrates an example 310 of early TXOP termination detection on the BSS primary channel 116 with notification sent by an OBSS NPCA STA/AP2 274. Both NPCA STA1/AP1 272 and OBSS NPCA STA/AP2 274 are wideband devices whose operational band covers both the BSS primary channel 116 and the its own NPCA primary channel 114. When there is an OBSS TXOP 280, with associated OBSS interference 278, occupying the BSS primary channel only, then NPCA STA1/AP1 switches 276 to the NPCA primary channel 114. The NPCA STA1/AP1 272 on the NPCA primary channel 114 contends 282 for channel access, and obtains channel access for NPCA STA1/AP1 TXOP 284. Then the OBSS NPCA STA/AP2 274 on the BSS primary channel detects the termination 312 of OBSS TXOP 280 and switches 314 to the NPCA primary channel 114 of NPCA STA1/AP1 272. The OBSS NPCA STA/AP2 process channel access on the NPCA primary channel. The OBSS NPCA STA/AP2 contends 316 for the channel, and upon obtaining the channel broadcasts a Notify signal 318 after obtaining the TXOP on the NPCA primary channel to announce the early termination of OBSS TXOP in the BSS primary channel. NPCA STA1/AP1 on the NPCA primary channel received the broadcasted Notification signal and initiate switch back 320. After that, the NPCA STA1/AP1 switches back to operate on the wideband channel that covers both the BSS primary channel and the NPCA primary channel. The NPCA STA1/AP1 contends 322 for the wideband channel (performing a backoff process) and performs channel access for NPCA STA1/AP1 TXOP 326 on the wideband channel, which is received 324.

### 7.3. Conditions for Early Switching Back

In at least one embodiment, the NPCA STA/AP shall satisfy the following conditions before processing an early switch back from the NPCA primary channel to the BSS primary channel.

The interfering OBSS TXOP must have terminated earlier than the OBSS basic Network Allocation Vector (NAV). Early switch back may be triggered by the NPCA AP if the AP detects the switch back signaling. The switch back signal could be relayed by the NPCA STA to the NPCA AP. The NPCA AP should not switch back from the NPCA primary channel to the BSS primary channel if the time since it switched to the NPCA primary channel hasn’t reached the NPCA Minimum Duration Threshold. The NPCA STA may switch back from the NPCA primary channel to the BSS primary channel if it received a switch back signal from the associated NPCA AP; this applies even if the time since it switched to the NPCA primary channel hasn’t reached the NPCA Minimum Duration Threshold.

When the early switch back occurs during a TXOP in the NPCA primary channel, the NPCA STA/AP should truncate the TXOP in the NPCA primary channel and then initiate the switching back. The truncation point should be after the successful transmission and reception of the ongoing PPDU.

### 8. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms "programming" or "program executable" as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A station apparatus for performing non-primary channel access (NPCA) in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD); (c) a processor of the STA; (d) a non-transitory memory storing instructions executable by the processor for wirelessly communicating over a communications medium with other STAs on an IEEE 802.11 wireless local area network (WLAN); and (e) wherein said instructions, when executed by the processor, perform steps of a wireless communications protocol, comprising: (e)(i) wherein the STA operates in the wireless communications protocol capable of performing non-primary channel access (NPCA) in a wireless network, as either an Access Point (AP) STA or a non-AP STA, for communicating with other STAs using a carrier sense multiple access/collision avoidance (CSMA/CA) mechanism, and wherein each STA has at least one primary channel and at least one non-primary channel access; (e)(ii) performing a switch from a first primary channel to a second primary channel, upon detecting that communication medium synchronization has been lost; (e)(iii) commencing a medium synchronization process after switching between the first primary channel and the second primary channel, as the second primary channel lacks valid previous virtual or physical carrier sense (CS) information; (e)(iv) contending for channel access during a medium synchronization time period; and (e)(v) transmitting an initial control frame or trigger frame over the second primary channel to an other STA and receiving response information from that other STA over the second primary channel regarding medium synchronization over the second primary channel.

A station apparatus for performing non-primary channel access (NPCA) in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD); (c) a processor of the STA; (d) a non-transitory memory storing instructions executable by the processor for wirelessly communicating over a communications medium with other STAs on an IEEE 802.11 wireless local area network (WLAN); and (e) wherein said instructions, when executed by the processor, perform steps of a wireless communications protocol, comprising: (e)(i) wherein the STA operates in the wireless communications protocol as either an Access Point (AP) STA or a non-AP STA, for communicating with other STAs using a carrier sense multiple access/collision avoidance (CSMA/CA) mechanism, and wherein each STA has at least one primary channel and at least one non-primary channel access; (e)(ii) determining, by the STA that medium synchronization has been lost on the BSS primary channel when an other basic service set (OBSS) transmission has interference exceeding a threshold level; (e)(iii) wherein the STA using the NPCA primary channel lacks valid previous virtual or physical carrier sense (CS) information on the NPCA primary channel, and the duration of the OBSS transmission on the primary channel that causes the STA lost medium synchronization on the NPCA primary channel occurs for a duration longer than a medium synchronization threshold; (e)(iv) initiating a switch to the NPCA primary channel by starting an NPCA medium synchronization delay timer and counting down that timer from the end of that OBSS transmission on the BSS primary channel that caused the loss of medium synchronization; (e)(v) contending for the NPCA primary channel for a duration of an NPCA medium synchronization delay time; (e)(vi) recovering medium synchronization by transmitting an NPCA initial control frame, or trigger frame, and receiving responses to allow synchronization.

A method for performing non-primary channel access (NPCA) in a wireless network, comprising: (a) communicating from a station (STA) configured as either a separate STA or as a STA within a multiple-link device (MLD), and having at least one modem coupled to at least one radio-frequency (RF) circuit, with each RF circuit connected to one or multiple antennas, with the station executing a wireless communications protocol by at least one processor executing instructions from a non-transitory memory for wirelessly communicating over a communications medium with other STAs on an IEEE 802.11 wireless local area network (WLAN); and (b) wherein the STA operates in the wireless communications protocol as either an Access Point (AP) STA or a non-AP STA, for communicating with other STAs using a carrier sense multiple access/collision avoidance (CSMA/CA) mechanism, and wherein each STA has at least one primary channel and at least one non-primary channel access; (c) performing a switch from a first primary channel to a second primary channel, as an NPCA primary channel, upon detecting that communication medium synchronization has been lost; (d) commencing a medium synchronization process after switching between the first primary channel and the second primary channel as NPCA primary channel, as the second primary channel lacks valid previous virtual or physical carrier sense (CS) information; (e) contending for channel access during a medium synchronization time period; and (f) transmitting an initial control frame or trigger frame over the second primary channel as NPCA primary channel, to an other STA and receiving response information from that other STA over the second primary channel regarding medium synchronization over the second primary channel.

An apparatus operating a wireless communication protocol in which a STA operating on the NPCA primary channel is considered to have lost medium synchronization when the OBSS transmissions on the BSS primary channel has caused certain level of interference on the NPCA primary channel, and the STA doesn’t have any valid previous virtual/physical CS information on the NPCA primary channel, and the duration of the OBSS transmission on the primary channel that causes the STA lost medium synchronization on the NPCA primary channel is greater than aMediumSyncThreshold; wherein the STA that has lost medium synchronization on NPCA primary channel shall start an NPCA MediumSyncDelay timer and begin counting down from the end of that OBSS transmission on the BSS primary channel that causes the STA lost medium synchronization on the NPCA primary channel if the OBSS transmission duration is greater than aMediumSyncThreshold, or if the OBSS transmission duration after the NPCA HE/NHT switch time and the actual NPCA switching delay is greater than anNPCAMediumSyncThreshold.

An apparatus operating a wireless communication protocol so that if a STA that operates on an NPCA primary channel has lost medium synchronization due to the OBSS transmission interference on the BSS primary channel, and its previous NPCA MediumSyncDelay timer has not expired/reset/initialized, then at the end of the OBSS transmission, the STA shall continue the previous NPCA MediumSyncDelay timer except that the STA may initialize the NPCA MediumSyncDelay timer when the duration of OBSS transmission duration is greater than aMediumSyncThreshold.

The apparatus or method any preceding or following implementation, wherein the first primary channel comprises a basic service set primary channel and the second primary channel comprises a non-primary channel access (NPCA) primary channel, or wherein the first primary channel comprises an NPCA primary channel and the second primary channel comprises a BSS primary channel.

The apparatus or method any preceding or following implementation, wherein detecting that communication medium synchronization has been lost, is performed by verifying that interference is occurring above a selected threshold for a given time period (T1).

The apparatus or method any preceding or following implementation, wherein the medium synchronization threshold time period spans at least a physical layer protocol data unit (PPDU) length of ready-to-send (RTS), clear-to-send (CTS), and acknowledgement (Ack) frames using non-high throughput (HT) or non-HT duplicate PPDU format with a given data rate, as well as the PPDU length of a typical blockAck (BA) frame.

The apparatus or method any preceding or following implementation, further comprising performing a switch back to the BSS primary channel when OBSS interference has dropped below the interference threshold for a given amount of time, then waiting over a synchronization delay period, before contending for and obtaining the BSS primary channel and performing communication to establish medium synchronization.

The apparatus or method any preceding or following implementation, further comprising performing an early switch back when an OBSS TXOP is truncated on the BSS primary channel, and thus the switch is performed earlier than at the end of the OBSS TXOP.

The apparatus or method any preceding or following implementation, further comprising resetting the NPCA medium synchronization delay timer to zero when: (i) the STA receives a MAC protocol data unit (MPDU) on the NPCA primary channel; or (2) when the STA receives a PPDU on the NPCA primary channel for which the RXVECTOR parameter TXOP_DURATION is not specified.

The apparatus or method any preceding or following implementation, further comprising the STA continuing a previous NPCA medium synchronization delay timer at the end of the OBSS transmission, when the NPCA primary channel has lost medium synchronization due to the OBSS transmission interference on the BSS primary channel, and its previous NPCA medium synchronization delay timer has not expired, been reset, or initialized.

The apparatus or method any preceding or following implementation, further comprising the STA continuing a previous NPCA medium synchronization delay timer at the end of the OBSS transmission, when the NPCA primary channel has lost medium synchronization due to the OBSS transmission interference on the BSS primary channel, except when the duration of OBSS transmission duration exceeds the medium synchronization threshold timer wherein the STA initializes the NPCA medium synchronization threshold timer.

The apparatus or method any preceding or following implementation, further comprising transmitting an NPCA initial control frame or NPCA trigger frame, and receiving responses, when the STA is capable of obtaining a TXOP while the NPCA medium synchronization delay timer has a nonzero value.

The apparatus or method any preceding or following implementation, wherein the STA supporting NPCA maintains at least one RF link dedicated to for carrier sense (CS) on the BSS primary channel when the STA switches to the NPCA primary channel.

The apparatus or method any preceding or following implementation, wherein a remaining RF link on the BSS primary channel is configured to detect an early termination of the OBSS TXOP.

The apparatus or method any preceding or following implementation, wherein if the STA is a wide band non-UHR STA then it processes carrier sensing on the BSS primary channel and signals OBSS TXOP termination on the wideband channel.

The apparatus or method any preceding or following implementation, wherein the STA being an OBSS NPCA STA or OBSS NPCA AP only occupies the BSS primary channel and is configured to switch to the NPCA primary channel of the NPCA STA/AP to announce early TXOP termination on the BSS primary channel.

The apparatus or method any preceding or following implementation, wherein the NPCA medium synchronization delay timer is a single timer, shared by all enhanced distributed channel access functions (EDCAFs) within a STA.

The apparatus or method any preceding or following implementation, wherein the NPCA medium synchronization delay timer can be set to a maximum PPDU time (aPPDUMaxTime), or set to a maximum PPDU time (aPPDUMaxTime) plus a short interframe space (aSIFS) time plus the response time of the previous PPDU.

The apparatus or method any preceding or following implementation, further comprising performing a switch back to the BSS primary channel when OBSS interference has dropped below an interference threshold for a given amount of time, then waiting over a synchronization delay period, before contending for and obtaining the BSS primary channel and performing communication to establish medium synchronization.

The apparatus or method any preceding or following implementation, wherein the STA supporting NPCA maintains at least one RF link dedicated to for carrier sense (CS) on the BSS primary channel when the STA switches to the NPCA primary channel.

The apparatus or method any preceding or following implementation, wherein the NPCA MediumSyncDelay timer is a single timer, shared by all EDCAFs within a STA, whose value could be set to, aPPDUMaxTime, or set to aPPDUMaxTime plus aSIFSTime plus the response time of the previous PPDU.

The apparatus or method any preceding or following implementation, wherein the NPCA MediumSyncDelay timer resets to zero when the STA receives an MPDU on the NPCA primary channel or when the STA receives a PPDU on the NPCA primary channel for which the RXVECTOR parameter TXOP_DURATION is not UNSPECIFIED.

The apparatus or method any preceding or following implementation, wherein a STA that is capable of obtaining a TXOP while the NPCA MediumSyncDelay timer has a nonzero value shall use dot11NPCAMSDOFDMEDthreshold to detect a channel busy condition in the NPCA primary 20 MHz channel.

The apparatus or method any preceding or following implementation, wherein the dot11NPCAMSDOFDMEDthreshold shall set to a value between -82dBm to -62dBm.

The apparatus or method any preceding or following implementation, wherein the STA shall perform CCA with dot11OFDMED threshold for the primary 20 MHz channel of the NPCA primary channel when the NPCA MediumSyncDelay timer has expired before it initiates a transmission.

The apparatus or method any preceding or following implementation, wherein the STA supporting NPCA shall maintain at least one RF link just for CS on the BSS primary channel when the STA switch to the NPCA primary channel. The remaining RF link on the BSS primary channel could detect the early termination of OBSS TXOP.

The apparatus or method any preceding or following implementation, wherein the wide band non-UHR STA should process carrier sensing on the BSS primary channel and signal OBSS TXOP termination on the wideband channel.

The apparatus or method any preceding or following implementation, wherein the OBSS NPCA STA/AP only occupies the BSS primary channel should be able switch to the NPCA primary channel of the NPCA STA/AP to announce the early TXOP termination on the BSS primary channel.

The apparatus or method any preceding or following implementation, wherein the NPCA AP should not switch back from the NPCA primary channel to the BSS primary channel if the time since it switched to the NPCA primary channel hasn’t reach the NPCA Minimum Duration Threshold.

The apparatus or method any preceding or following implementation, wherein the NPCA STA may switch back from the NPCA primary channel to the BSS primary channel if it received switch back signal from the associated NPCA AP. This applies even if the time since it switched to the NPCA primary channel hasn’t reach the NPCA Minimum Duration Threshold.

The apparatus or method any preceding or following implementation, wherein when the early switch back happens during a TXOP in the NPCA primary channel, the NPCA STA/AP should truncate the TXOP in the NPCA primary channel and then initiate the switching back. The truncation point should be after the successful transmission and reception of the ongoing PPDU.

As used herein, the term "implementation" is intended to include, without limitation, embodiments, examples, or other forms of practicing the technology described herein.

As used herein, the singular terms "a," "an," and "the" may include plural referents unless the context clearly dictates otherwise. Reference to an object in the singular is not intended to mean "one and only one" unless explicitly so stated, but rather "one or more."

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term "set" refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms "comprises," "comprising," "has", "having," "includes", "including," "contains", "containing" or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by "comprises . . . a", "has . . . a", "includes . . . a", "contains . . . a" does not, without more constraints, preclude the existence of additional identical elements in the process, method, article, apparatus, or system, that comprises, has, includes, contains the element.

As used herein, the terms "approximately", "approximate", "substantially", "substantial", "essentially", and "about", or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ± 10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%. For example, "substantially" aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term "coupled" as used herein is defined as connected, although not necessarily directly and not necessarily mechanically. A device or structure that is "configured" in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a "means plus function" element unless the element is expressly recited using the phrase "means for". No claim element herein is to be construed as a "step plus function" element unless the element is expressly recited using the phrase "step for".

What is claimed is:

1. A station apparatus for performing non-primary channel access (NPCA) in a wireless network, the apparatus comprising:
(a) at least one modem coupled to at least one radio-frequency (RF) circuit, with each RF circuit connected to one or multiple antennas;
(b) wherein the station (STA) is configured as a separate STA or as a STA within a multiple-link device (MLD);
(c) a processor of the STA;
(d) a non-transitory memory storing instructions executable by the processor for wirelessly communicating over a communications medium with other STAs on an IEEE 802.11 wireless local area network (WLAN); and
(e) wherein the instructions, when executed by the processor, perform steps of a wireless communications protocol, comprising:
(i) wherein the STA operates in the wireless communications protocol capable of performing non-primary channel access (NPCA) in a wireless network, as either an Access Point (AP) STA or a non-AP STA, for communicating with other STAs using a carrier sense multiple access/collision avoidance (CSMA/CA) mechanism, and wherein each STA has at least one primary channel and at least one non-primary channel access;
(ii) performing a switch from a first primary channel to a second primary channel, upon detecting that communication medium synchronization has been lost;
(iii) commencing a medium synchronization process after switching between the first primary channel and the second primary channel, as the second primary channel lacks valid previous virtual or physical carrier sense (CS) information;
(iv) contending for channel access during a medium synchronization time period; and
(v) transmitting an initial control frame or trigger frame over the second primary channel to an other STA and receiving response information from that other STA over the second primary channel regarding medium synchronization over the second primary channel.

2. The apparatus of claim 1, wherein the first primary channel comprises a basic service set primary channel and the second primary channel comprises a non-primary channel access (NPCA) primary channel, or wherein the first primary channel comprises an NPCA primary channel and the second primary channel comprises a BSS primary channel.

3. The apparatus of claim 1, wherein detecting that communication medium synchronization has been lost, is performed by verifying that interference is occurring above a selected threshold for a given time period (T1).

4. The apparatus of claim 1, wherein the medium synchronization threshold time period spans at least a physical layer protocol data unit (PPDU) length of ready-to-send (RTS), clear-to-send (CTS), and acknowledgement (Ack) frames using non-high throughput (HT) or non-HT duplicate PPDU format with a given data rate, as well as the PPDU length of a typical blockAck (BA) frame.

5. The apparatus of claim 1, further comprising performing a switch back to the BSS primary channel when OBSS interference has dropped below the interference threshold for a given amount of time, then waiting over a synchronization delay period, before contending for and obtaining the BSS primary channel and performing communication to establish medium synchronization.

6. The apparatus of claim 1, further comprising performing an early switch back when an OBSS TXOP is truncated on the BSS primary channel, and thus the switch is performed earlier than at the end of the OBSS TXOP.

7. The apparatus of claim 1, further comprising resetting the NPCA medium synchronization delay timer to zero when: (i) the STA receives a MAC protocol data unit (MPDU) on the NPCA primary channel; or (2) when the STA receives a PPDU on the NPCA primary channel for which the RXVECTOR parameter TXOP_DURATION is not specified.

8. The apparatus of claim 1, further comprising the STA continuing a previous NPCA medium synchronization delay timer at the end of the OBSS transmission, when the NPCA primary channel has lost medium synchronization due to the OBSS transmission interference on the BSS primary channel, and its previous NPCA medium synchronization delay timer has not expired, been reset, or initialized.

9. The apparatus of claim 1, further comprising the STA continuing a previous NPCA medium synchronization delay timer at the end of the OBSS transmission, when the NPCA primary channel has lost medium synchronization due to the OBSS transmission interference on the BSS primary channel, except when the duration of OBSS transmission duration exceeds the medium synchronization threshold timer wherein the STA initializes the NPCA medium synchronization threshold timer.

10. The apparatus of claim 1, further comprising transmitting an NPCA initial control frame or NPCA trigger frame, and receiving responses, when the STA is capable of obtaining a TXOP while the NPCA medium synchronization delay timer has a nonzero value.

11. The apparatus of claim 1, wherein the STA supporting NPCA maintains at least one RF link dedicated to for carrier sense (CS) on the BSS primary channel when the STA switches to the NPCA primary channel.

12. The apparatus of claim 11, wherein a remaining RF link on the BSS primary channel is configured to detect an early termination of the OBSS TXOP.

13. The apparatus of claim 1, wherein if the STA is a wide band non-UHR STA then it processes carrier sensing on the BSS primary channel and signals OBSS TXOP termination on the wideband channel.

14. The apparatus of claim 1, wherein the STA being an OBSS NPCA STA or OBSS NPCA AP only occupies the BSS primary channel and is configured to switch to the NPCA primary channel of the NPCA STA/AP to announce early TXOP termination on the BSS primary channel.

15. A station apparatus for performing non-primary channel access (NPCA) in a wireless network, the apparatus comprising:
(a) at least one modem coupled to at least one radio-frequency (RF) circuit, with each RF circuit connected to one or multiple antennas;
(b) wherein the station (STA) is configured as a separate STA or as a STA within a multiple-link device (MLD);
(c) a processor of the STA;
(d) a non-transitory memory storing instructions executable by the processor for wirelessly communicating over a communications medium with other STAs on an IEEE 802.11 wireless local area network (WLAN); and
(e) wherein the instructions, when executed by the processor, perform steps of a wireless communications protocol, comprising:
(i) wherein the STA operates in the wireless communications protocol as either an Access Point (AP) STA or a non-AP STA, for communicating with other STAs using a carrier sense multiple access/collision avoidance (CSMA/CA) mechanism, and wherein each STA has at least one primary channel and at least one non-primary channel access;
(ii) determining, by the STA that medium synchronization has been lost on the BSS primary channel when an other basic service set (OBSS) transmission has interference exceeding a threshold level;
(iii) wherein the STA using the NPCA primary channel lacks valid previous virtual or physical carrier sense (CS) information on the NPCA primary channel, and the duration of the OBSS transmission on the primary channel that causes the STA lost medium synchronization on the NPCA primary channel occurs for a duration longer than a medium synchronization threshold;
(iv) initiating a switch to the NPCA primary channel by starting an NPCA medium synchronization delay timer and counting down that timer from the end of that OBSS transmission on the BSS primary channel that caused the loss of medium synchronization;
(v) contending for the NPCA primary channel for a duration of an NPCA medium synchronization delay time;
(vi) recovering medium synchronization by transmitting an NPCA initial control frame, or trigger frame, and receiving responses to allow synchronization.

16. The apparatus of claim 15, wherein the NPCA medium synchronization delay timer is a single timer, shared by all enhanced distributed channel access functions (EDCAFs) within a STA.

17. The apparatus of claim 16, wherein the NPCA medium synchronization delay timer can be set to a maximum PPDU time (aPPDUMaxTime), or set to a maximum PPDU time (aPPDUMaxTime) plus a short interframe space (aSIFS) time plus the response time of the previous PPDU.

18. A method for performing non-primary channel access (NPCA) in a wireless network, comprising:
(a) communicating from a station (STA) configured as either a separate STA or as a STA within a multiple-link device (MLD), and having at least one modem coupled to at least one radio-frequency (RF) circuit, with each RF circuit connected to one or multiple antennas, with the station executing a wireless communications protocol by at least one processor executing instructions from a non-transitory memory for wirelessly communicating over a communications medium with other STAs on an IEEE 802.11 wireless local area network (WLAN); and
(b) wherein the STA operates in the wireless communications protocol as either an Access Point (AP) STA or a non-AP STA, for communicating with other STAs using a carrier sense multiple access/collision avoidance (CSMA/CA) mechanism, and wherein each STA has at least one primary channel and at least one non-primary channel access;
(c) performing a switch from a first primary channel to a second primary channel, as an NPCA primary channel, upon detecting that communication medium synchronization has been lost;
(d) commencing a medium synchronization process after switching between the first primary channel and the second primary channel as NPCA primary channel, as the second primary channel lacks valid previous virtual or physical carrier sense (CS) information;
(e) contending for channel access during a medium synchronization time period; and
(f) transmitting an initial control frame or trigger frame over the second primary channel as NPCA primary channel, to an other STA and receiving response information from that other STA over the second primary channel regarding medium synchronization over the second primary channel.

19. The method of claim 18, further comprising performing a switch back to the BSS primary channel when OBSS interference has dropped below an interference threshold for a given amount of time, then waiting over a synchronization delay period, before contending for and obtaining the BSS primary channel and performing communication to establish medium synchronization.

20. The method of claim 18, wherein the STA supporting NPCA maintains at least one RF link dedicated to for carrier sense (CS) on the BSS primary channel when the STA switches to the NPCA primary channel.
